(19) United States
(12) Patent Application Publication
(10) Pub. No.: US 2018/0198936 A1
(43) Pub. Date: Jul. 12, 2018

(54) CURL-CORRECTING DEVICE AND IMAGE FORMING APPARATUS INCORPORATING SAME

(71) Applicant: Hiroshi Kajiyama, Tokyo (JP)

(72) Inventor: Hiroshi Kajiyama, Tokyo (JP)

(73) Assignee: Ricoh Company, Ltd., Tokyo (JP)

(21) Appl. No.: 15/831,305

(22) Filed: Dec. 4, 2017

(30) Foreign Application Priority Data
Jan. 6, 2017 (JP) 2017-000837
May 15, 2017 (JP) 2017-096179

(51) Int. Cl. H04N 1/00; H04N 1/32; G03G 15/00

(52) U.S. Cl. CPC H04N 1/00647; H04N 1/32593; B65H 2404/262; B65H 2301/44312; B65H 2301/51256; G03G 15/6576

(57) ABSTRACT

A curl-correcting device includes a roller, a belt, a pair of rollers, and an adjuster. The roller is disposed facing the convex side of a curled sheet. The belt is rotatable in a predetermined direction to convey the sheet sandwiched between the roller and the belt. The pair of rollers is located at positions of an upstream side and a downstream side in a rotation direction of the belt, and each abuts the roller via the belt. The adjuster adjusts a winding angle at which the belt is wound around the roller by varying an interval between the pair of rollers in the rotation direction of the belt.

### CROSS-REFERENCE TO RELATED APPLICATIONS

This patent application is based on and claims priority pursuant to 35 U.S.C. § 119 to Japanese Patent Applications No. 2017-000837, filed on Jan. 6, 2017, and No. 2017-096179, filed on May 15, 2017 in the Japanese Patent Office, the entire disclosures of which are hereby incorporated by reference herein.

### BACKGROUND

### Technical Field

Embodiments of the present disclosure relate to a curl-correcting device for correcting curling of a sheet of recording media, and an image forming apparatus incorporating the curl-correcting device, such as a copier, a printer, a facsimile machine, or a multifunction peripheral thereof.

### Background Art

Conventionally, in an image forming apparatus such as a copier or a printer, a curl-correcting device is known. The curl-correcting device is disposed downstream from a fixing device to correct curling of a sheet of recording media (recording medium) in a fixing process.

### SUMMARY

This specification describes an improved curl-correcting device and an image forming apparatus incorporating the curl-correcting device, which, in one illustrative embodiment, includes a roller, a belt, a pair of rollers, and an adjuster. The roller is disposed facing the convex side of a curled sheet. The belt is rotatable in a predetermined direction to convey the sheet sandwiched between the roller and the belt. The pair of rollers is located at positions of an upstream side and a downstream side in a rotation direction of the belt, and each abuts the roller via the belt. The adjuster adjusts a winding angle at which the belt is wound around the roller by varying an interval between the pair of rollers in the rotation direction of the belt.

### BRIEF DESCRIPTION OF THE SEVERAL VIEWS OF THE DRAWINGS

A more complete appreciation of the embodiments and many of the attendant advantages and features thereof can be readily obtained and understood from the following detailed description with reference to the accompanying drawings, wherein:

FIG. 1 is a schematic diagram illustrating a configuration of an image forming apparatus according to a first embodiment;

FIG. 2 is a schematic diagram illustrating a fixing device and a curl-correcting device;

FIG. 3 is a schematic diagram illustrating a configuration of the curl-correcting device;

FIGS. 4A and 4B are schematic diagrams illustrating an operation of a main part of the curl-correcting device;

FIG. 5 is a schematic diagram illustrating a configuration of the curl-correcting device according to a second embodiment of the present disclosure;

FIGS. 6A and 6B are schematic diagrams illustrating an operation of a main part of the curl-correcting device illustrated in FIG. 5;

FIG. 7 is a schematic diagram illustrating a configuration of the curl-correcting device according to a third embodiment of the present disclosure;

FIGS. 8A and 8B are schematic diagrams illustrating an operation of a main part of the curl-correcting device illustrated in FIG. 7; and

FIG. 9 is a schematic diagram illustrating a fixing device and a curl-correcting device of a variation in the present disclosure.

### DETAILED DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

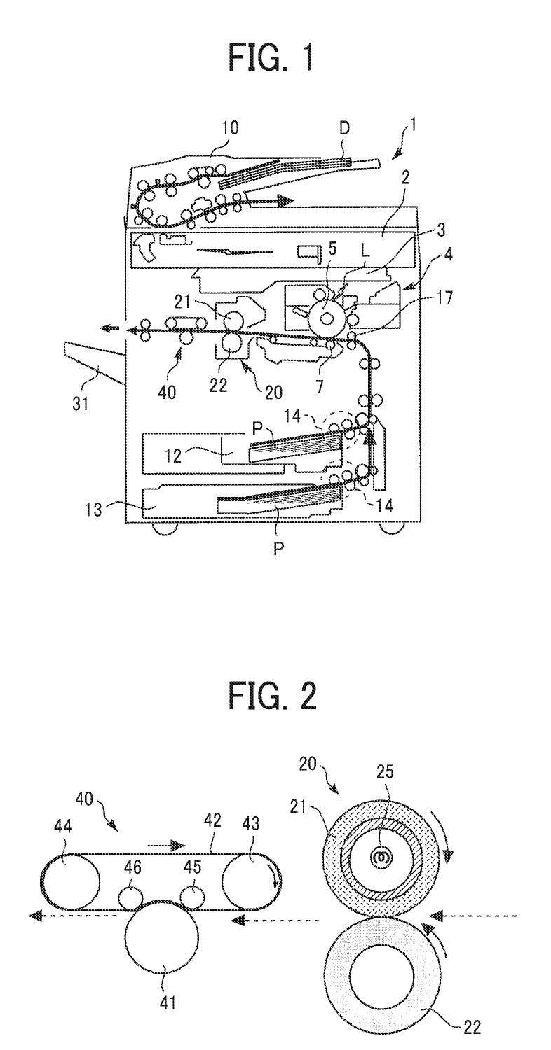

The configurations related to the present disclosure are described based on embodiments illustrated in the accompanied drawings from FIGS. 1 to 9. It is to be noted that identical reference numerals are assigned to identical components or equivalents and description of those components is simplified or omitted.

Referring now to the drawings, wherein like reference numerals designate identical or corresponding parts throughout the several diagrams thereof, and particularly to FIG. 1, an image forming apparatus 1 employing electrophotography, according to an embodiment of the present disclosure is described.

### First Embodiment

With reference to FIGS. 1 to 4, a first embodiment of the present disclosure is described in detail below.

The overall configuration and operation of the image forming apparatus 1 is described with reference to FIG. 1.

In FIG. 1, a copier as the image forming apparatus 1 includes a document reading section 2 to read image data of a document D optically, an exposure device 3 to irradiate a photoconductor drum 5 with exposure light L based on image data read by the document reading section 2, an image forming unit 4 to form a toner image (an image) on the photoconductor drum 5, a transfer device 7 (an image forming section) to transfer the toner image formed on the photoconductor drum 5 to a sheet P, a document feeder 10 (an automatic document feeder) to convey the set document D to the document reading section 2, sheet trays 12 and 13 (sheet feeders) in which the sheet P is stored, a registration rollers 17 (timing rollers) to convey the sheet P toward the transfer device 7, a fixing device 20 to fix the toner image (an unfixed image) borne on the sheet P, a fixing roller 21 disposed in the fixing device 20, a pressure roller 22 disposed in the fixing device 20, an output tray 31 on which the sheet P discharged from a main body of the image forming apparatus 1 is stacked, a curl-correcting device 40 to correct a curl generated in the sheet P.

Conveyance rollers of the document feeder 10 conveys (feeds) the document D from a document table to out of the document feeder in a direction of an arrow in FIG. 1 via a position over the document reading section 2. When the document D passes over the document reading section 2, the document reading section 2 optically reads image data of the document D passing over the document reading section 2. The optical image data read by the document reading section 2 is converted to electric signals and transmitted to the exposure device 3. The exposure device 3 irradiates the photoconductor drum 5 of the image forming unit 4 with exposure light L such as laser light or the like based on the electric signals.

In the image forming unit 4, the photoconductor drum 5 rotates clockwise in FIG. 1. The image forming unit 4 executes a predetermined series of image forming processes that includes charging, exposure, and developing, and forms an image (a toner image) corresponding to the image data on the photoconductor drum 5. The transfer device 7 as the image forming section transfers the image formed on the photoconductor drum 5 onto the sheet P conveyed by a registration roller 17.

The sheet P conveyed to the transfer device 7 (the image forming section) is selected and conveyed as follows. Firstly, among a plurality of sheet trays 12 and 13 of the image forming apparatus 1, one sheet tray is selected automatically or manually. For example, in the following description, the uppermost sheet tray 12 is selected. A sheet feeding mechanism 14 including a feed roller, a pick-up roller, a backup roller, etc. conveys the uppermost one of the sheets P stored in the sheet tray 12 from the sheet tray 12 to a conveyance path. The sheet P conveyed by the sheet feeding mechanism 14 passes through the conveyance path including a plurality of conveyance rollers and reaches the position of registration rollers 17.

When the image formed on the photoconductor drum 5 and the sheet P meet at a target position, the registration rollers 17 sends the sheet P which has reached the position of the registration roller 17 toward the transfer device 7 (the image forming section). After the transfer process, the sheet P that has passed through the position of the transfer device 7 reaches the fixing device 20 via the conveyance path. In the fixing process, the fixing device 20 sandwiches the sheet P between the fixing roller 21 and the pressure roller 22, and fixes the toner image on the sheet P by the heat from the fixing roller 21 and the pressures from both the fixing roller 21 and the pressing roller 22. The sheet P after the fixing process in which the toner image is fixed is sent out from a fixing nip between the fixing roller 21 and the pressure roller 22. The sheet p reaches a position of the curl-correcting device 40. The curl-correcting device 40 corrects a curl of the sheet P in a curl-correcting process. After the curl-correcting process, the sheet P is discharged from the main body of the image forming apparatus 1 and is stacked on an output tray 31 as an output, thus completing a series of image forming processes.

With reference to FIG. 2, a description is given of a configuration and operation of the fixing device 20 disposed in the image forming apparatus 1. As illustrated in FIG. 2, the fixing device 20 includes the fixing roller 21 as a rotating body for fixing, the pressure roller 22 as a rotating body for pressure, and a heater 25 as a heating device.

The fixing roller 21 is a roller including a multi-layer structure that layers, in sequence, a release layer that is a surface layer and an elastic layer on a surface of a metal tube. The elastic layer of the fixing roller 21 is made of an elastic material such as fluoro rubber, silicon rubber, or silicon rubber foam. The release layer of the fixing roller 21 is made of tetrafluoroethylene-perfluoroalkyl vinyl ether copolymer (PFA) or the like. The fixing roller 21 rotates clockwise in FIG. 2. The heater 25 as a heating device (a heat source) is fixed inside the fixing roller 21, that is, inside a hollow structure of the fixing roller 21.

The heater as the heating device fixed inside the fixing roller 21 is a halogen heater. One halogen heater or a plurality of halogen heaters may be used. Both ends of the halogen heater are secured to a side plate of the fixing device 20. As the image forming apparatus 1 is powered on, a power source supplies power to the heater 25. A processor 70 controls electric power supply to the heater 25. Radiant heat form the heater 25 heats the fixing roller 21. Heat of the surface of the fixing roller 21 is applied to the toner image on the sheet P. The processor 70 controls electric power supplied to the heater 25 based on a temperature of the outer circumferential surface of the fixing roller 21 detected by a temperature sensor that faces the outer circumferential surface of the fixing roller 21 without contacting the fixing roller 21. Specifically, the processor 70 applies an alternating current voltage to the heater 25 for a time determined based on the temperature detected by the temperature sensor. Above described electric power control of the heater 25 enables to adjust the temperature of the fixing roller 21, that is, a fixing temperature, to a desired fixing temperature, that is, a target control temperature.

The pressure roller 22 includes a metal cored bar, an elastic layer formed on the outer circumferential surface of the cored bar via a bonding layer, and a surface layer that is a release layer formed on the outer surface of the elastic layer. The elastic layer of the pressure roller 22 has a thickness of a few millimeters and includes elastic material such as insulating expandable silicone rubber, fluoro-rubber, and silicone rubber. The surface layer of the pressure roller 25 has a thickness of from tens of micrometers to hundreds of micrometers and includes low-friction material such as conductive tetrafluoroethylene-perfluoroalkyl vinyl ether copolymer (PFA), that is, a PFA tube. The pressure roller 22 is pressed against the fixing roller 21. The pressure roller 22 forms a fixing nip through which the sheet P is conveyed.

The fixing device 20 described above operates as follows in the fixing process. As the image forming apparatus 1 is powered on, the power source applies alternating current voltage to the heater 25 and supplies power to the heater 25. After the image forming apparatus 1 receives a print command (a print job command), a driving motor as a driving device rotates the fixing roller 21 in an arrow direction (a clockwise direction) in FIG. 2. Rotation of the fixing roller 21 drives and rotates the pressure roller 22 in an arrow direction (a counterclockwise direction) in FIG. 2. The sheet P bearing the unfixed image (the toner image) after the transfer process is conveyed in a dashed arrow direction in FIG. 2 and sent to the fixing nip portion between the fixing roller 21 and the pressure roller 22 that presses the fixing roller 21. The heat from the fixing roller 21 and the pressures from the fixing roller 21 and the pressure roller 22 fix the toner image on the surface of the sheet P. After the fixing device 20 fixes the toner image, the rotation of the fixing roller 21 and the pressure roller 22 sends the sheet P from the fixing nip portion toward the curl-correcting device 40.

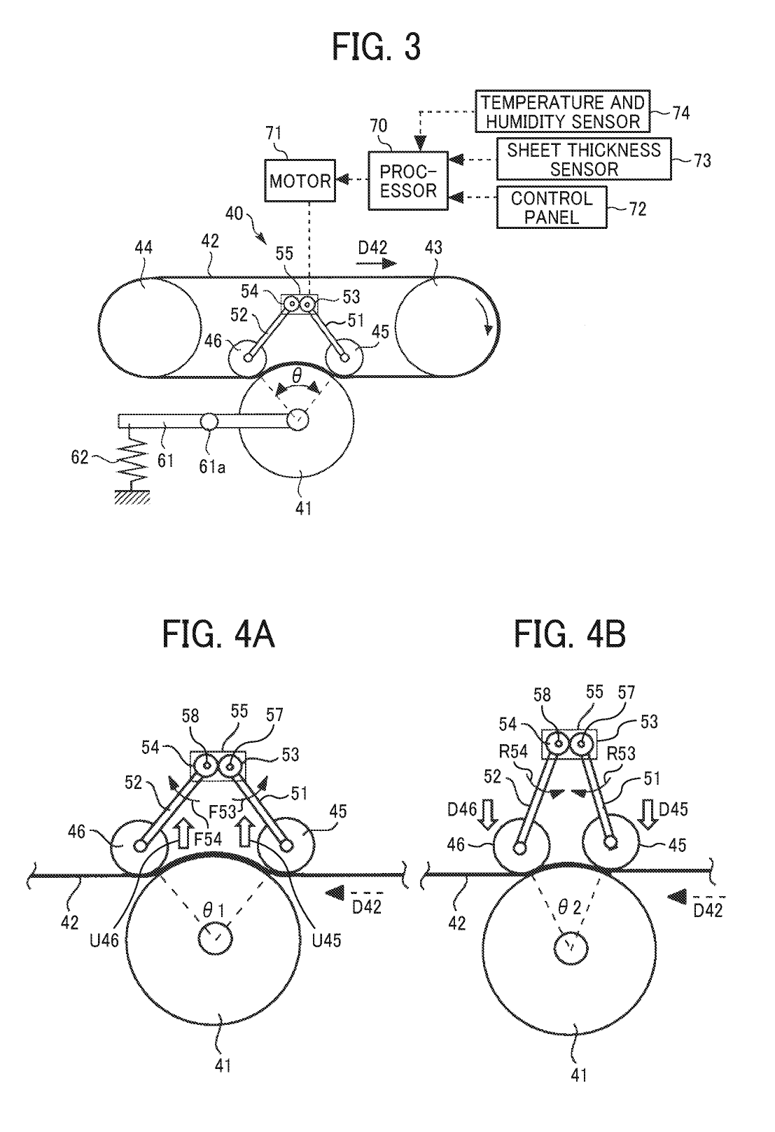

Hereinafter, the configuration and operation of the curl-correcting device 40 (the image forming apparatus 1) characterized in the first embodiment is described in detail. The curl-correcting device 40 corrects the curl on the sheet P in a direction predetermined in advance. The curl is a curl that curves convex downward in FIG. 2, FIG. 3, etc. along the direction of conveyance of the sheet P. The curl-correcting device 40 is disposed downstream of the fixing device 20 in the direction of conveyance of the sheet P (that is, on the downstream side in the direction of conveyance of the sheet P and on the left side in FIG. 2). In the fixing process, the sheet P is conveyed along the outer peripheral surface of the fixing roller 21, and given heat from the fixing roller 21 and pressure from the fixing nip portion. This process forms a curl in a specific direction on the sheet P.

With reference to FIG. 3, the curl-correcting device 40 includes a roller 41, a belt 42, a driving roller 43, a driven roller 44, a pair of a first roller 45 and a second roller 46, a pair of a first arm 51 and a second arm 52, a pair of a first gear 53 and a second gear 54, a holder 55, a pressing arm 61, a tension spring 62, a motor 71 as an adjuster, and the like.

The roller 41 is disposed facing the convex side of the curl of the sheet P. Specifically, the roller 41 faces the non-fixing surface of the sheet P (the lower surface of the sheet P) after the fixing process. The roller 41 is formed of a material having a certain degree of rigidity (surface hardness) like metal or the like. An end of the pressing arm 61 holds the roller 41 rotatably. The pressing arm 61 is rotatable around a rotating shaft 61a. A casing of the curl-correcting device 40 holds the pressing arm 61. The other end of the pressing arm 61 is attached to an end of the tension spring 62. The other end of the tension spring 62 is attached to the casing of the curl-correcting device 40. Tension of the tension spring 62 is set to a relatively small value. The tension of the tension spring 62 causes the roller 41 to abut on the belt 42 with a relatively small pressure contact force to form a nip portion. The nip portion is formed along a curved surface corresponding to the curvature of the outer periphery of the roller 41. As described above, the pressing arm 61 and the tension spring 62 function as a biasing member to bias the roller 41 toward the belt 42.

The belt 42 travels in a predetermined direction that is a rotation direction of the driving roller 43, that is, a clockwise direction illustrated in FIG. 3, and conveys the sheet P while sandwiching the sheet P with the roller 41. The belt 42 is disposed facing the fixing surface (upper surface) of the sheet P after the fixing process. Specifically, the belt 42 is an endless belt having a multilayer structure in which a release layer made of tetrafluoroethylene bafluoroalkyl vinyl ether copolymer resin (PFA) or the like is formed on a base layer made of resin such as polyimide. The belt 42 is stretched and supported by the driving roller 43 and the driven roller 44. When the driving motor drives and rotates the driving roller 43 in the clockwise direction of FIG. 3, the belt 42 runs and rotates in the arrow direction (the clockwise direction) in FIG. 3. A traveling of the belt 42 causes the roller 41 contacting the belt 42 to be driven and rotated counterclockwise in FIG. 3. While the sheet P after the fixing process is pinched by the nip portion between the belt 42 and the roller 41, the traveling of the belt 42 conveys the sheet P in a direction of conveyance along a rotation direction D42 of the belt 42. At this time, the sheet P is curled to follow the curved surface having the curvature of the nip portion. That is, the sheet P is given a reverse curl that is a curl in a direction opposite to the curl direction given by the fixing process. Therefore, the curl of the sheet P given by the fixing process is corrected.

The first roller 45 and the second roller 46 are spaced apart. A first roller 45 is disposed on the upstream side in the rotation direction D42 of the belt 42. The second roller 46 is disposed downstream of the belt 42 in the rotation direction D42 of the belt 42. Each of the pair of the first roller 45 and the second roller 46 abuts against the roller 41 via the belt 42. The first roller 45, a first arm 51, and a first gear 53 that are disposed on the upstream side and the second roller 46, a second arm 52, a second gear 54 that are disposed on the downstream side are disposed so as to be axisymmetric with respect to an imaginary line passing through the center of the nip portion and the center of the roller 41. Specifically, the pair of the first roller 45 and the second roller 46 is made of the same material and shape. The pair of the first roller 45 and the second roller 46 is formed of a resin material having a certain degree of rigidity (and a certain degree of surface hardness).

As illustrated in FIG. 3, the roller 41 is brought into contact with the pair of the first roller 45 and the second roller 46 via the belt 42, and the belt 42 is wound around the roller 41 between the pair of the first roller 45 and the second roller 46. As described above, the pressing arm 61 and the tension spring 62 work as the biasing member to bias the roller 41.

With reference to FIG. 4A and FIG. 4B, the curl-correcting device 40 according to the first embodiment includes the adjuster to adjust a winding angle θ in which the belt 42 is wound around the roller 41 by varying an interval between the pair of the first roller 45 and the second roller 46 in the rotation direction D42 of the belt 42, that is, a leftward direction. Specifically, the first arm 51 and the second arm 52 formed to be pivotable about a pair of spindles 57 and 58 hold the pair of the first roller 45 and the second roller 46, respectively. The first gear 53 and the second gear 54 configured to be rotatable together with the first arm 51 and the second arm 52 are set on the pair of spindles 57 and 58 of the pair of the first arm 51 and the second arm 52, respectively. The pair of the first gear 53 and the second gear 54 mesh with each other. The motor 71 as the adjuster rotates either one of the pair of the first gear 53 and the second gear 54, which is the first gear 53 in the first embodiment, in forward and reverse directions.

One end of the first arm 51 rotatably holds the first roller 45. On the other end of the first arm 51, the first gear 53 is set fixedly. One end of the second arm 52 rotatably holds the second roller 46. On the other end of the second arm 52, the second gear 54 is set fixedly. Both the spindle 57 for rotatably holding the first gear 53 and the spindle 58 for rotatably holding the second gear 54 are fixed in or secured to the holder 55 held in a casing of the curl-correcting device 40. The first gear 53 meshes with a motor gear of the motor 71. The motor 71, the pair of the first gear 53 and the second gear 54, and the pair of the first arm 51 and the second arm 52 work as the adjuster to change the interval between the pair of the first roller 45 and the second roller 46 in the rotation direction D42 of the belt 42 (that is, the winding angle θ of the belt 42 with respect to the roller 41).

With reference to FIG. 4A, when the motor 71 rotates the first gear 53 forward in a direction F53 (that is, the counterclockwise direction in FIG. 4A), the second gear 54 rotates clockwise in FIG. 4A in a direction F54 in accordance with rotation of the first gear 53 by the same rotation angle as the rotation angle of the first gear 53. Due to a rotation of the first gear 53, the first arm 51 holding the first roller 45 pivots counterclockwise in FIG. 4A. Due to a rotation of the second gear 54, the second arm 52 holding the second roller 46 pivots clockwise in FIG. 4A. This operation increases the interval between the two rollers, that is, the first roller 45 and the second roller 46.

This operation drives the first roller 45 and the second roller 46 upward, that is, in directions U45 and U46 of white arrows in FIG. 4A and weakens a tension of the belt 42. However, the roller 41 is biased by the pressing arm 61 and the tension spring 62 (biasing member) so as to abut against the first roller 45 and the second roller 46 and extend the interval on the belt 42 between the first roller 45 and the second roller 46. Therefore, a winding angle θ1 of the belt 42 with respect to the roller 41 increases, the tension of the belt 42 does not weaken, and a nip pressure (a force with which the roller 41 presses against the belt 42) hardly varies.

On the other hand, referring to FIG. 4B, when the motor 71 rotates the first gear 53 reverse in a direction R53 that is the clockwise direction in FIG. 4B, the second gear 54 is driven and rotated in accordance with rotation of the first gear 53 by the same rotation angle as the first gear 53 in a direction R54, that is, in the counterclockwise direction in FIG. 4B. Due to a rotation of the first gear 53, the first arm 51 holding the first roller 45 pivots clockwise in FIG. 4B. Due to a rotation of the second gear 54, the second arm 52 holding the second roller 46 pivots counterclockwise in FIG. 4B. This operation decreases the interval between the first roller 45 and the second roller 46.

This operation drives the first roller 45 and the second roller 46 downward in directions D45 and D46 of white arrows in FIG. 4B and strengthens the tension of the belt 42. However, the roller 41 is biased by the pressing arm 61 and the tension spring 62 (biasing member) so as to abut against the first roller 45 and the second roller 46 and narrow the interval on the belt 42 between the first roller 45 and the second roller 46. Therefore, the winding angle θ1 of the belt 42 with respect to the roller 41 decreases to a winding angle θ2, the tension of the belt 42 does not strengthen, and a nip pressure (a force in which the roller 41 presses against the belt 42) hardly varies.

As described above, in the first embodiment, it is possible to adjust the winding angle θ of the roller 41 with respect to the belt 42 efficiently and highly accurately. In addition, in the first embodiment, it is possible to prevent disadvantages caused by a large variation in the nip pressure (the force in which the roller 41 presses against the belt 42) due to a large variation in the tension in the belt 42 when the winding angle θ1 is adjusted. Therefore, in the first embodiment, the curl can be corrected sufficiently accurately.

Further, because the variation in the nip pressure (the force in which the roller 41 presses against the belt 42) at a time when the winding angle θ1 is adjusted is small, it is possible to prevent an abnormal image caused by a large nip pressure that damages the image on the sheet P.

In the first embodiment, when the thickness of the sheet P is small, the processor 70 controls the adjuster configured by the motor 71 and other parts to adjust the interval between the pair of the first roller 45 and the second roller 46 in the rotation direction D42 of the belt 42 to be greater and adjust the winding angle θ to be greater than when the thickness of the sheet P is great.

Specifically, the processor 70 detects the thickness of the sheet P based on information of the sheet P that a user inputs to the control panel 72 attached in the exterior part of the image forming apparatus 1. The user may input a thickness value of the sheet P, or may simply input whether the sheet P is a thin sheet. When the user inputs the thickness value, the processor 70 determines whether the thickness of the sheet P is smaller than a predetermined value. This predetermined value is determined by experiments using the curl-correcting device 40 of the present disclosure and the image forming apparatus 1 that uses the curl-correcting device 40. When the processor 70 determines the thickness of the sheet P is not smaller than the predetermined value, that is, the sheet P is a thick sheet, because the sheet P does not curl easily, it is not necessary to correct the curl strongly. Therefore, as illustrated in FIG. 4B, the processor 70 controls the motor 71 so that the interval between the pair of the first roller 45 and the second roller 46 in the rotation direction D42 of the belt 42 (that is, the winding angle θ) becomes small. On the other hand, when the processor 70 determines the thickness of the sheet P is smaller than the predetermined value, that is, the sheet P is a thin sheet, because the sheet P curls greatly, it is preferable to correct the curl strongly. Therefore, as illustrated in FIG. 4A, the processor 70 controls the motor 71 so that the interval between the pair of the first roller 45 and the second roller 46 in the rotation direction D42 of the belt 42 (that is, the winding angle θ) becomes big. The reason why this control is effective is that the force causing inverse curling of the sheet P is substantially proportional to the magnitude of the winding angle θ.

The execution of such control makes it possible to correct curling of the sheet P appropriately irrespective of the thickness of the sheet P. That is, such control makes it possible to eject sheet P with no curl.

A known sheet thickness sensor 73 that is, for example, disposed in the sheet feeding mechanism 14 may directly detect the thickness of the sheet P when such control is performed. The known sheet thickness sensor 73 inputs the thickness value of the sheet P to the processor 70. That is, when the processor determines the thickness value detected by the sheet thickness sensor 73 is greater than the predetermined value, the processor 70 controls the motor 71 so that the winding angle θ becomes small. When the processor determines the thickness value detected by the sheet thickness sensor 73 is equal to or smaller than the predetermined value, the processor 70 controls the motor 71 so that the winding angle θ becomes big.

Further, in the first embodiment, when a curl amount of the sheet P is large, the processor 70 controls the adjuster configured by the motor 71 and other parts to widen the interval between the pair of the first roller 45 and the second roller 46 in the rotation direction D42 of the belt 42 and change the winding angle θ bigger than when the curl amount of the sheet P is small. In performing such control, based on readings from a detector that directly detects the curl amount of the sheet P after the fixing process, the processor 70 controls the motor 71 to adjust the winding angle θ. The detector above described is, for example, a distance measurement sensor to detect unevenness of the sheet P. As with the above-described control based on the sheet thickness, the processor 70 may be input the curl amount of the sheet P from the control panel 72 or the detector. The processor may control the adjuster based on a predetermined value determined by experiments, or so that the angle θ is continuously changed in accordance with the detected curl amount.

Further, in the first embodiment, when the sheet P has high moisture, the processor 70 controls the adjuster configured by the motor 71 and other parts to change the interval between the pair of the first roller 45 and the second roller 46 in the rotation direction D42 of the belt 42 bigger and the winding angle θ bigger than when the sheet P has low moisture. Because the sheet P having a high moisture curls bigger than the sheet P having a low moisture. In performing such control, the processor controls a temperature and humidity sensor 74 illustrated in FIG. 3, which is disposed near the sheet tray 12, to detect an absolute humidity, and indirectly obtain a moisture content of the sheet P set in the sheet tray 12. Based on a result of the moisture content of the sheet P, the processor controls the motor 71 to change the winding angle θ. Instead, a moisture meter may directly detect the moisture content in the sheet P set in the sheet tray 12, and the processor 70 controls the motor 71 to change the winding angle θ based on a result of the moisture content of the sheet P. As with the above-described control based on the sheet thickness, the processor 70 is input the moisture content of the sheet P from the temperature and humidity sensor 74. The processor may control the adjuster based on a predetermined value determined by experiments, or so that the angle θ is continuously changed in accordance with the detected moisture content of the sheet P.

Further, in the first embodiment, when the sheet P has a feature that makes it easy to curl, the processor 70 controls the adjuster configured by the motor 71 and other parts to change the interval between the pair of the first roller 45 and the second roller 46 in the rotation direction D42 of the belt 42 bigger and the winding angle θ bigger than when the sheet P has a feature that makes it difficult to curl. Because different kinds of sheet P (different paper types) cause different curl. In such a case, the processor 70 may detect the type of the sheet P based on the information of the sheet P input to the control panel 72 by the user. The processor 70 may collate the detected result with information stored in the processor 70, which is information on a relation between the type of the sheet P and a curl amount, and control the motor 71 to change the winding angle θ based on a collation result. Recycled paper is cited as a paper type that is easy to curl. Ordinary paper and coated paper are cited as paper types that are difficult to curl. In the first embodiment, when the user inputs the type of the sheet P as the recycled paper, that is, the sheet P that is easy to curl into the control panel 72, the processor 70 controls the adjuster to change the interval between the pair of the first roller 45 and the second roller 46 in the rotation direction D42 of the belt 42 bigger and the winding angle θ bigger than when the user does not input the type of the sheet P as the recycled paper, that is, the sheet P that is not easy to curl. This control makes it possible to improve the accuracy of curl-correction regardless of the type of sheet P.

As described above, the curl-correcting device 40 in the first embodiment includes the belt 42 to convey the sheet P while sandwiching the sheet P with the roller 41 that faces the convex side of the curl of the sheet P, the pair of the first roller 45 and the second roller 46 that is located at a remote position of the upstream side and the downstream side in the rotation direction D42 of the belt 42 so that the roller 41 abuts the pair of the first roller 45 and the second roller 46 via the belt 42, the pressing arm 61 and the tension spring 62 (the biasing member) to bias the roller 41 so that the belt 42 is wound around the roller 41 between the pair of the first roller 45 and the second roller 46, The motor 71 (the adjuster) to change the winding angle θ of the belt 42 with respect to the roller 41 by varying the interval between the pair of the first roller 45 and the second roller 46 in the rotation direction D42 of the belt 42. This makes it possible to correct the curl with high accuracy.

### Second Embodiment

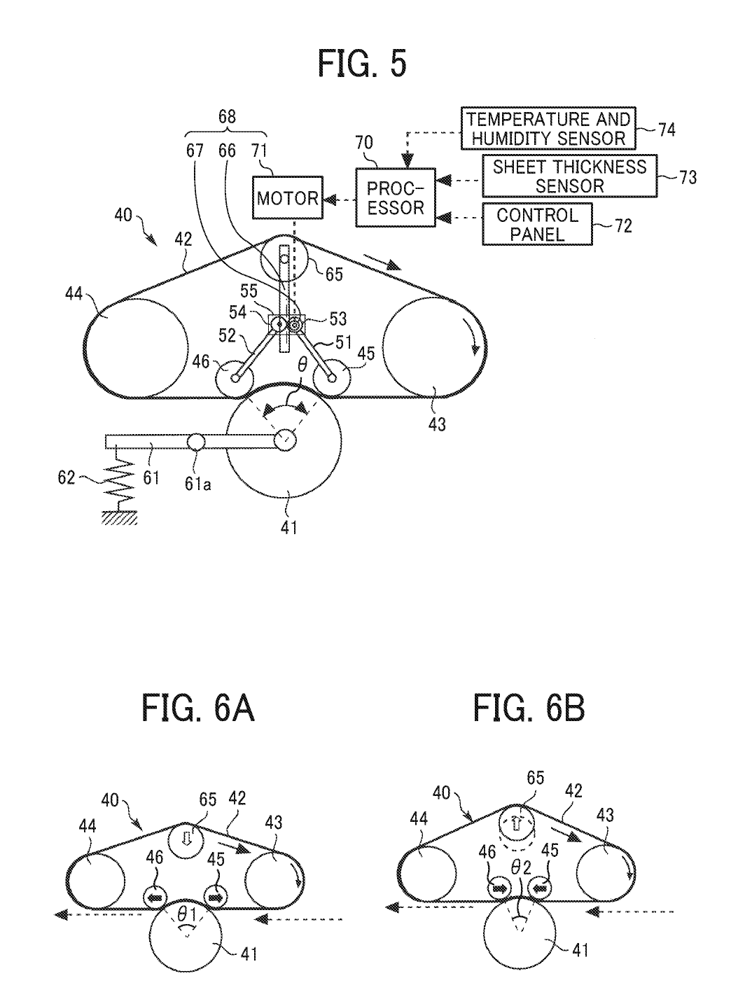

With reference to FIG. 5 and FIGS. 6A and 6B, a second embodiment of the present disclosure is described in detail. FIG. 5 is a schematic diagram illustrating a configuration of the curl-correcting device 40 according to the second embodiment, which corresponds to FIG. 3 in the first embodiment. FIGS. 6A and 6B are schematic diagrams illustrating an operation of the curl-correcting device 40. The difference between the curl-correcting device 40 of the second embodiment and the first embodiment is an existence of an abutment member (tensioner 65) to adjust the tension of the belt 42.

With reference to FIGS. 5, 6A, and 6B as in the first embodiment, the curl-correcting device 40 according to the second embodiment also includes the roller 41, the belt 42, the driving roller 43, the driven roller 44, the pair of the first roller 45 and the second roller 46, the pair of the first arm 51 and the second arm 52, the pair of the first gear 53 and the second gear 54, the holder 55, the pressing arm 61, the tension spring 62, the motor 71 as the adjuster, and the like.

In addition, the curl-correcting device 40 according to the second embodiment includes the tensioner 65 as the abutment member that abuts the belt 42, and an adjustment unit 68 that adjusts the tension of the belt 42 by moving the tensioner 65 (the abutment member) and includes a movable member 66, a pinion gear 67, and the motor 71. As illustrated in FIG. 6A, when the processor 70 controls the motor 71 (the adjuster) so as to increase the interval between the pair of the first roller 45 and the second roller 46 in the rotation direction D42 of the belt 42 and make the winding angle θ bigger (that is, make the winding angle θ1), the adjustment unit 68 moves the tensioner 65 (the abutment member) in a direction to reduce a contact pressure of the tensioner 65 against the belt 42 than when the processor 70 controls the motor 71 (the adjuster) so as to decrease the interval between the pair of the first roller 45 and the second roller 46 in the rotation direction D42 of the belt 42 and make the winding angle θ smaller (that is, make the winding angle θ2).

Specifically, the tensioner 65 as the abutment member is a metal roller that abuts the inner circumferential surface of the belt 42 and is inside the curl-correcting device 40 and on an upper side. The tensioner 65 is rotatably held to rotate accompanying the movement of the belt 42. The adjustment unit 68 that moves the tensioner 65 (the abutment member) includes the movable member 66, the pinion gear 67, and the motor 71. The pinion gear 67 is disposed coaxially with the first gear 53 and rotated in forward and reverse directions by the motor 71 that also functions as the adjuster for moving the first roller 45 and the second roller 46. The tensioner 65 is rotatably held on one end of the movable member 66. The other end (which is indicated by a dashed-dotted line in FIG. 5) of the movable member 66 has a rack gear meshing with the pinion gear 67. The casing of the curl-correcting device 40 holds the movable member 66 to be movable in the vertical direction.

As illustrated in FIGS. 5 and 6A, based on the control described in the first embodiment, when the processor 70 controls the motor 71 to move the pair of the first roller 45 and the second roller 46 in the direction of the black arrow, make the winding angle θ of the belt 42 bigger, and set the winding angle θ1 of the belt 42, the same motor 71 rotates the pinion gear 67 in the counterclockwise direction, and moves the movable member 66 and the tensioner 65 in the direction of the white arrow, that is, downward direction, which is the direction of weakening the belt tension. By contrast, as illustrated in FIGS. 5 and 6B, based on the control described in the first embodiment, when the processor 70 controls the motor 71 to move the pair of the first roller 45 and the second roller 46 in the direction of the black arrow, make the winding angle θ of the belt 42 smaller, and set the winding angle θ2 of the belt 42, the same motor 71 rotates the pinion gear 67 in the clockwise direction, and moves the movable member 66 and the tensioner 65 in the direction of the white arrow, that is, upward direction, which is the direction of strengthening the belt tension.

As described above, the vertical movement of the tensioner 65 that is moved by the adjustment unit 68 in accordance with the change in the winding angle θ of the belt 42 prevents a big variation in the tension of the belt 42 and the pressure of the nip portion (the nip pressure) between the belt 42 and the roller 41 and maintains the tension of the belt 42 and the pressure of the nip portion (the nip pressure) between the belt 42 and the roller 41 at a substantially constant and appropriate value. Therefore, this configuration prevents a disadvantage such as uneven gloss, scratches on the fixed image of the sheet P, or the like, which are caused by too large nip pressure at the nip portion between the belt 42 and the roller 41 that is due to a change of the winding angle θ of the belt 42. To further comprehensively explain, since the large winding angle θ of the belt 42 increases the tension applied to the belt 42, without adjustment by the tensioner 65, the tension of the belt 42 may increase. The large tension of the belt 42 increases the nip pressure between the belt 42 and the roller 41. In particular, such a phenomenon is noticeable when the circumferential length of the belt 42 is relatively short. In the second embodiment, the vertical movement of the tensioner 65 that is moved by the adjustment unit 68 in accordance with the change in the winding angle θ of the belt optimizes the belt tension and avoids the disadvantages described above.

In the second embodiment, the rack and pinion are used in the adjustment unit 68, but the adjustment unit 68 is not limited this and alternatively, for example, a worm gear may be used in the adjustment unit 68. Further, in the second embodiment, the motor 71 as the adjuster also functions as the adjustment unit 68. On the other hand, the adjuster and the adjustment unit 68 may not be used at the same time but may be provided separately. Further, in the second embodiment, by detecting the rotation angle of the motor 71, the first gear 53, or the pinion gear 67 using an encoder or the like, the winding angle θ and the position of the tensioner 65 may be determined.

As described above, the curl-correcting device 40 in the second embodiment also includes, as in the first embodiment, the belt 42 to convey the sheet P while sandwiching the sheet P with the roller 41 that faces the convex side of the curl of the sheet P, the pair of the first roller 45 and the second roller 46 that is located at a remote position of the upstream side and the downstream side in the rotation direction D42 of the belt 42 so that the roller 41 abuts the pair of the first roller 45 and the second roller 46 via the belt 42, the pressing arm 61 and the tension spring 62 (the biasing member) to bias the roller 41 so that the belt 42 is wound around the roller 41 between the pair of the first roller 45 and the second roller 46, the motor 71 (the adjuster) to change the winding angle θ of the belt 42 with respect to the roller 41 by varying the interval between the pair of the first roller 45 and the second roller 46 in the rotation direction D42 of the belt 42. This makes it possible to correct the curl with high accuracy.

### Third Embodiment

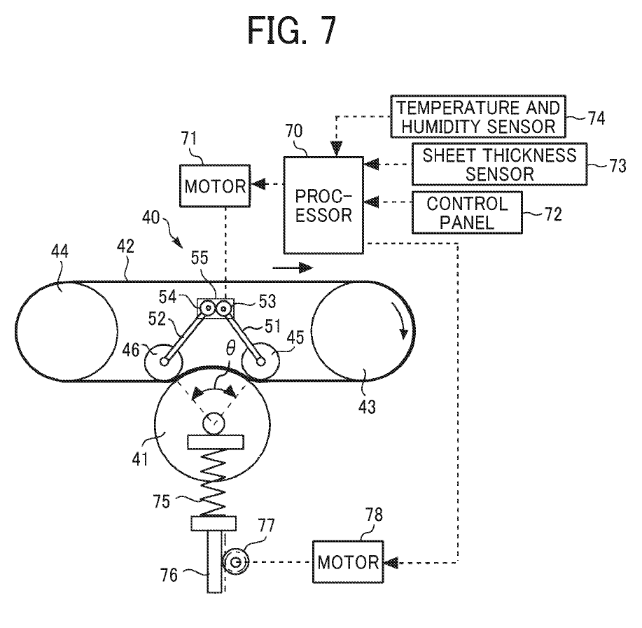

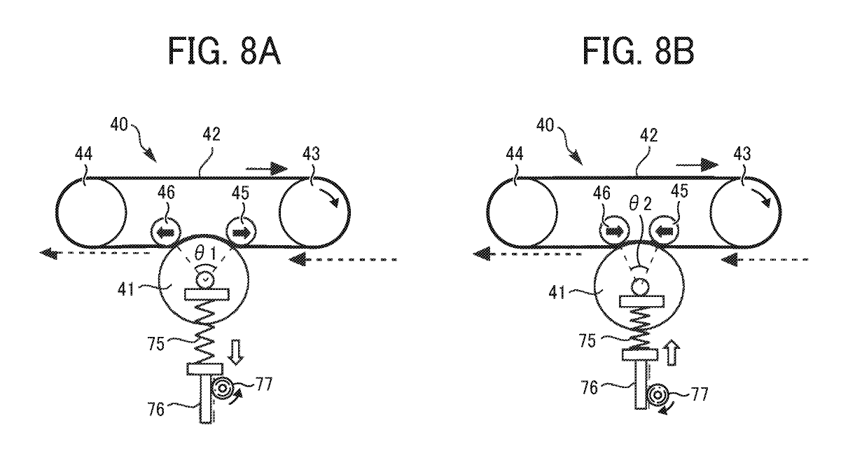

With reference to FIGS. 7, 8A, and 8B, a third embodiment of the present disclosure is described in detail. FIG. 7 is a schematic diagram illustrating a configuration of the curl-correcting device 40 according to the third embodiment, which corresponds to FIG. 3 in the first embodiment. FIGS. 8A and 8B are schematic diagrams illustrating an operation of the curl-correcting device 40. The difference between the curl-correcting device 40 of the third embodiment and that of the first embodiment is an existence of a biasing member that is possible to adjust a biasing force (a pressing force) for urging the roller 41 toward the belt 42.

With reference to FIGS. 7, 8A, and 8B, as in the first embodiment, the curl-correcting device 40 according to the third embodiment also includes the roller 41, the belt 42, the driving roller 43, the driven roller 44, the pair of the first roller 45 and the second roller 46, the pair of the first arm 51 and the second arm 52, the pair of the first gear 53 and the second gear 54, the holder 55, the biasing member that biases the roller 41, the motor 71 as the adjuster, and the like. The third embodiment is different from the above embodiment in the following points. To adjust the biasing force for biasing the roller 41 toward the belt 42, the biasing member that biases the roller 41 so that the belt 42 is wound around the roller 41 between the pair of the first roller 45 and the second roller 46 includes a compression spring 75, a rack and pinion including a moving member 76 and a pinion gear 77, and a motor 78.

Specifically, as illustrated in FIGS. 7, 8A, and 8B, one end of the compression spring 75 is coupled to a bearing of the roller 41, and the other end of the compression spring 75 is coupled to the moving member 76. The casing of the curl-correcting device 40 holds the moving member 76 to be movable in the vertical direction. The moving member 76 has a rack gear portion that meshes with the pinion gear 77 disposed in the casing of the curl-correcting device. In such a configuration, the processor 70 controls the motor 78 to rotate the pinion gear 77 in a clockwise direction or a counterclockwise direction. A rotation of the pinion gear 77 moves the moving member 76 up and down to change an expansion and contraction of the compression spring 75. A change in the expansion and contraction of the compression spring 75 changes the biasing force (the pressing force) of the roller 41 with respect to the belt 42.

In the third embodiment, the processor 70 controls the biasing member including the compression spring 75, the rack and pinion including a moving member 76 and a pinion gear 77, and the motor 78. When the thickness of the conveyed sheet P is small, the processor 70 sets the biasing force of the roller 41 with respect to the belt 42 smaller than when the thickness of the conveyed sheet P is great.

Specifically, the processor 70 detects the thickness of the sheet P based on information on the sheet P input by the user to the control panel 72. When the user uses the thick sheet as the sheet P, since the thick sheet does not cause a large curl, the processor 70 does not need to strengthen the urging force for correcting the curl. Therefore, when the sheet P is the thick sheet, as illustrated in FIG. 8B, the processor 70 controls the motor 71 so that the interval between the pair of the first roller 45 and the second roller 46 in the rotation direction D42 of the belt 42 (that is, winding angle θ) becomes small. However, when the urging force (the pressing force) of the roller 41 to the belt 42 is too small, a strong stiffness of the thick sheet prevents formation of a good nip portion between the belt 42 and the roller 41. Therefore, in the third embodiment, when the user uses the thick sheet as the sheet P, as illustrated in FIG. 8B, the processor 70 controls the motor 78 to rotate the pinion gear 77 in the clockwise direction, moves the moving member 76 upward, contracts the compression spring 75, and increases the urging force (the pressing force) of the roller 41 with respect to the belt 42.

On the other hand, when the user uses the thin sheet as the sheet P, since the thin sheet causes a large curl, the processor 70 needs to strengthen the urging force for correcting the curl. Therefore, when the sheet P is the thin sheet, as illustrated in FIG. 8A, the processor 70 controls the motor 71 so that the interval between the pair of the first roller 45 and the second roller 46 in the rotation direction D42 of the belt 42 (that is, winding angle θ) becomes big. Even if the urging force (the pressing force) of the roller 41 to the belt 42 is weak, a weak stiffness of the thin sheet does not prevent formation of a good nip portion between the belt 42 and the roller 41. In consideration of the influence on the image on the sheet P, it is preferable to set the pressing force (nip pressure) at the nip portion as small as possible. From these facts, in the third embodiment, when the sheet P which the user uses is not thick paper but plain paper or thin paper, as illustrated in FIG. 8A, the processor 70 controls the motor 78 to rotate the pinion gear 77 in the counterclockwise direction, move the moving member 76 downward, extend the compression spring 75, and reduce the urging force (the pressing force) of the roller 41 with respect to the belt 42.

In the third embodiment, based on at least one of the curl amount, the type of the sheet P, and the moisture content of the sheet P that is conveyed, the processor 70 controls the biasing member including the compression spring 75, the rack and pinion including the moving member 76 and the pinion gear 77, and the motor 78 to adjust the urging force of the roller 41 with respect to the belt 42. Specifically, the processor 70 detects the curl amount, the type of the sheet P, and the moisture content of the sheet P by the detection method described in the first embodiment. When the processor 70 determines that the curl amount of the sheet P becomes big, the processor 70 controls the motor 71 to set the interval between the pair of the first roller 45 and the second roller 46 (the winding angle θ) bigger than when the processor 70 determines that the curl amount of the sheet P becomes small. As described above, when the interval between the pair of the first roller 45 and the second roller 46 in the rotation direction D42 of the belt 42 (the winding angle θ) becomes big, it is preferable to set the pressing force bigger in order to form the good nip portion than when the interval between the pair of the first roller 45 and the second roller 46 in the rotation direction D42 of the belt 42 (the winding angle θ) becomes small. Therefore, the processor 70 controls the biasing member including the compression spring 75, the rack and pinion including the moving member 76 and the pinion gear 77, and the motor 78 so that the urging force (the pressing force) of the roller 41 with respect to the belt 42 becomes big.

In the third embodiment, the biasing member including the compression spring 75, the rack and pinion including the moving member 76 and the pinion gear 77, and the motor 78 may be configured so that a manual operation of an operator changes the urging force of the roller 41 toward the belt 42. Specifically, the image forming apparatus is configured as follows. The operator such as the user operates the control panel 72 to control the biasing member including the compression spring 75, the rack and pinion including the moving member 76 and the pinion gear 77, and the motor 78 and adjust the urging force (the pressing force) of the roller 41 toward the belt 42. In consideration of the influence on the image on the sheet P, it is preferable to set the pressing force (the nip pressure) at the nip portion between the roller 41 and the belt 42 as small as possible. On the other hand, a plurality of factors such as the thickness of the sheet P and the curl amount affect the formation of the good nip portion. Therefore, a configuration in which the operator can manipulate the urging force of the roller 41 with respect to the belt 42 freely and adjust the urging force to a desired amount enables proper adjustment according to the actual use state of the device.

As described above, the curl-correcting device 40 according to the third embodiment also includes, as in the respective embodiments, the belt 42 to convey the sheet P while sandwiching the sheet P with the roller 41 that faces the convex side of the curl of the sheet P, the pair of the first roller 45 and the second roller 46 located at upstream and downstream side in the rotation direction D42 of the belt 42 so that the roller 41 abuts the pair of the first roller 45 and the second roller 46 via the belt 42, the compression spring 75 as the biasing member to bias the roller 41 so that the belt 42 is wound around the roller 41 between the pair of the first roller 45 and the second roller 46, the motor 71 (the adjuster) to change the winding angle θ of the belt 42 with respect to the roller 41 by varying the interval between the pair of the first roller 45 and the second roller 46 in the rotation direction D42 of the belt 42. This makes it possible to correct the curl with high accuracy.

In each of the above embodiments, the fixing device 20 using the roller including the heater 25 is disposed on the upstream of the curl-correcting device 40 according to the present disclosure. However, the configuration of the fixing device 20 disposed on the upstream of the curl-correcting device 40 is not limited to this. The fixing device 20 may be a fixing device including a thermal heater and a belt, a fixing device of an electromagnetic induction system (IH system), or a fixing device of a resistance heating type. Even when any of the fixing devices is used, the same effects as in the above embodiments can be obtained.

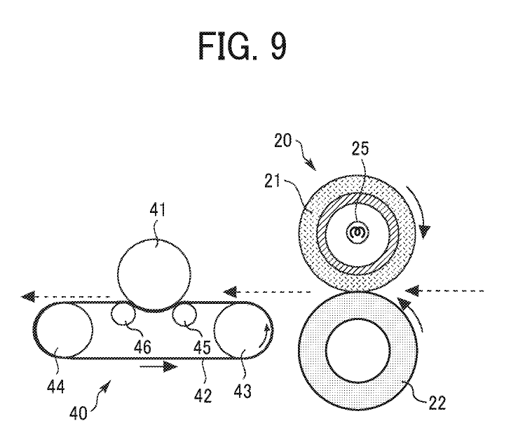

In the image forming apparatus according to each of the above-described embodiments, the curl generated on the sheet P after the fixing process is curved concavely on the fixing surface side. That is, the curl curves convex downward as illustrated in FIGS. 2, 3, and 5. The curl-correcting device 40 according to the present disclosure is applied to correct such curling. On the other hand, the configuration of the image forming apparatus 1 may be such that the curl occurring on the sheet P after the fixing process curves convexly toward the fixing surface side. That is, the curl curves convex upward in FIGS. 2, 3, and 5. The curl-correcting device 40 according to the present disclosure may also be applied to such the image forming apparatus 1. In such a case, as illustrated in FIG. 9, the curl-correcting device 40 includes a roller 41 disposed facing the fixing surface of the sheet P after the fixing process and a belt 42 disposed facing the non-fixing surface of the sheet P after the fixing process. In the curl-correcting device 40 configured as described above, the processor 70 performs the same control as in each of the above-described embodiments. With the above-described configuration, the same effects as those of the above-described embodiments can be obtained.

It is to be noted that it is clear that the present disclosure is not limited to the above-described embodiments, and variations of the above-described teachings are possible within the technical principles of the present disclosure. The number, position, shape of the components of the above described embodiments are not limited to those described above.

What is claimed is:

1. A curl-correcting device comprising:
a roller disposed facing a convex side of a curled sheet;
a belt rotatable in a predetermined rotation direction to convey the curled sheet sandwiched between the roller and the belt, the belt being wound around the roller at a winding angle;
a pair of rollers that is arranged in the rotation direction of the belt with an interval between the pair of rollers, the pair of rollers each abutting the roller via the belt; and
an adjuster to change the interval between the pair of rollers so as to adjust the winding angle of the belt.

2. The curl-correcting device according to claim 1, further comprising:
a pair of arms to hold the pair of rollers, respectively;
a pair of spindles about which the pair of arms is pivotable, respectively; and
a pair of gears disposed at the pair of spindles, respectively, and rotatable with the pair of arms, the pair of gears meshing each other,
wherein the adjuster includes a motor that rotates either one of the pair of gears in forward and reverse.

3. The curl-correcting device according to claim 1, further comprising:
a processor to determine a curl amount of the curled sheet,
the processor controlling the adjuster to change the interval between the pair of rollers in the rotation direction of the belt based on the curl amount of the curled sheet.

4. The curl-correcting device according to claim 1, further comprising:
a processor to determine a thickness of the sheet,
the processor controlling the adjuster to change the interval between the pair of rollers in the rotation direction of the belt based on the thickness of the sheet.

5. The curl-correcting device according to claim 1, further comprising:
a processor to determine a moisture of the sheet,
the processor controlling the adjuster to change the interval between the pair of rollers in the rotation direction of the belt based on the moisture of the sheet.

6. The curl-correcting device according to claim 1, further comprising:
a processor to determine a type of the sheet,
the processor controlling the adjuster to change the interval between the pair of rollers in the rotation direction of the belt based on the type of the sheet.

7. The curl-correcting device according to claim 1, further comprising:
an abutment member to abut against the belt; and
an adjustment unit to adjust a tension of the belt by moving the abutment member,
wherein the adjustment unit moves the abutment member when the adjuster changes the interval between the pair of rollers in the rotation direction of the belt.

8. The curl-correcting device according to claim 1, further comprising:
a biasing member to bias the roller against the belt to wind the belt around the roller.

9. The curl-correcting device according to claim 8,
wherein the biasing member biases the roller against the belt with a biasing force that is variable based on at least one of a curl amount of the curled sheet, and a thickness, a type, and a moisture of the sheet before curling.

10. The curl-correcting device according to claim 8,
wherein the biasing member changes a biasing force by manual operation.

11. An image forming apparatus comprising:
a fixing device to fix a toner image on a sheet; and
a curl-correcting device disposed downstream from the fixing device in a direction of conveyance of the sheet,
the curl-correcting device including:
a roller disposed facing a convex side of a curled sheet;
a belt rotatable in a predetermined rotation direction to convey the curled sheet sandwiched between the roller and the belt, the belt being wound around the roller at a winding angle;
a pair of rollers that is arranged in the rotation direction of the belt with an interval between the pair of rollers, the pair of rollers each abutting the roller via the belt; and
an adjuster to change the interval between the pair of rollers so as to adjust the winding angle of the belt.

12. The image forming apparatus according to claim 11,
wherein the roller is not disposed facing the toner image fixed on the curled sheet and the belt is disposed facing the toner image fixed on the curled sheet.

13. The image forming apparatus according to claim 11,
wherein the roller is disposed facing the toner image fixed on the curled sheet, and the belt is not disposed facing the toner image fixed on the curled sheet.
